(19) United States
(12) Patent Application Publication
(10) Pub. No.: US 2006/0264257 A1
(43) Pub. Date: Nov. 23, 2006

(54) Gaming machine having gaming loyalty features

(76) Inventors: Joel R. Jaffe, Glenview, IL (US); Jeremy M. Hornik, Chicago, IL (US); Peter R. Anderson, Chicago, IL (US); John D. Flint, Sharon, MA (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/394,067

(22) Filed: Mar. 30, 2006

Related U.S. Application Data
(60) Provisional application No. 60/666,894, filed on Mar. 31, 2005.

(51) Int. Cl. A63F 13/00

(52) U.S. Cl. 463/20; 463/26

(57) ABSTRACT

A gaming machine for conducting a wagering game includes a wager input device for receiving inputs from a player during a wagering game, such that the inputs include a wager amount. At least one display for displaying a plurality of symbols is included in the gaming machine. The displayed symbols indicate a randomly selected outcome selected from a plurality of outcomes. A player information reader for receiving a player identifier is also a part of the gaming machine. The player identifier links the player to a player's account that contains statistics regarding the player. In response to the statistics meeting a predetermined level, the player is granted a reward. The predetermined level is based on game play at one of a plurality of a predetermined manufacturer's gaming machines.

### CROSS-REFERENCE TO RELATED APPLICATION

This application claims the benefit of priority of U.S. Provisional Patent Application No. 60/666,894, filed Mar. 31, 2005, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine providing rewards to players.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Gaming machines have utilized a variety of mechanisms to present various combinations of symbols, and to award prizes, money, or other awards associated with certain predefined winning combinations. Traditional slot machines, for example, utilize a plurality of reels (either mechanical, or simulated on a video display) and at least one payline, with certain combination of symbols landing on the payline constituting winning combinations for which awards are given to the player in accordance with a pay table. Video poker gaming machines offer an alternative wherein winning combinations correspond with traditional winning poker hands. However, traditional gaming machines fail to adequately provide rewards for players who are loyal to the games. Thus, a need exists for a gaming machine having rewards for players who are loyal. The present invention is directed to satisfying one or more of these needs and solving other problems.

### SUMMARY OF THE INVENTION

According to one aspect of the present invention, a gaming machine includes a wager input device for receiving a wager to play a wagering game. At least one display for displaying a randomly selected outcome. A player information reader for receiving a player identifier is a part of the gaming machine. The player identifier is associated with a player's account that includes statistics. A reward is awarded in response to the statistics meeting at least one predetermined criterion, associated with game play of a selected manufacturer's games.

According to another aspect of the invention, a method of conducting a wagering game on a gaming machine comprises receiving a player identifier associated with a player's account. Information from the player's account is monitored. The information is related to wagering game play. In response to the information meeting at least one predetermined criterion, a reward is awarded. The at least one criterion is associated with game play of a selected manufacturer's games.

According to yet another aspect of the invention, a computer readable storage medium is encoded with instructions for directing a gaming device to perform the above method.

According to another embodiment of the present invention, a method of conducting a wagering game on a gaming machine includes receiving a wager to play the wagering game. A player identifier is received, which links a player to a player's account. The player's account includes game play statistics and biographical information. A randomly selected outcome of the wagering game is displayed. In response to the randomly selected outcome being a winning outcome, the player is awarded a reward. The method also compiles additional statistics during the wagering game, updates the game play statistics in the player's account to include the additional statistics, and grants the player a reward in response to the updated game play statistics meeting a predetermined level, the predetermined level being based on game play at any of a plurality of a predetermined manufacturer's gaming machines.

According to another embodiment of the present invention, a gaming system is provided. The gaming system includes a plurality of linked gaming machines having a common feature. Each of the linked gaming machines has a wager input device for receiving a wager to play a wagering game. A wagering game of one of the plurality of linked gaming machines is different from a wagering game of another of the plurality of linked gaming machines. Also included in each gaming machine is at least one display for displaying a randomly selected outcome. A player information reader for receiving a player identifier is also included. The player identifier links is associated with a player's account that includes information. A reward is awarded in response to the information meeting at least one predetermined criterion. The at least one predetermined criterion is associated with game play of a selected manufacturer's games.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention.

FIG. 2 is a block diagram of a control system suitable for operating the gaming machine.

FIG. 3 is an initial screen of the primary display of the gaming machine of FIG. 1.

FIG. 4 is a subsequent screen of the primary display of the gaming machine of FIG. 1.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

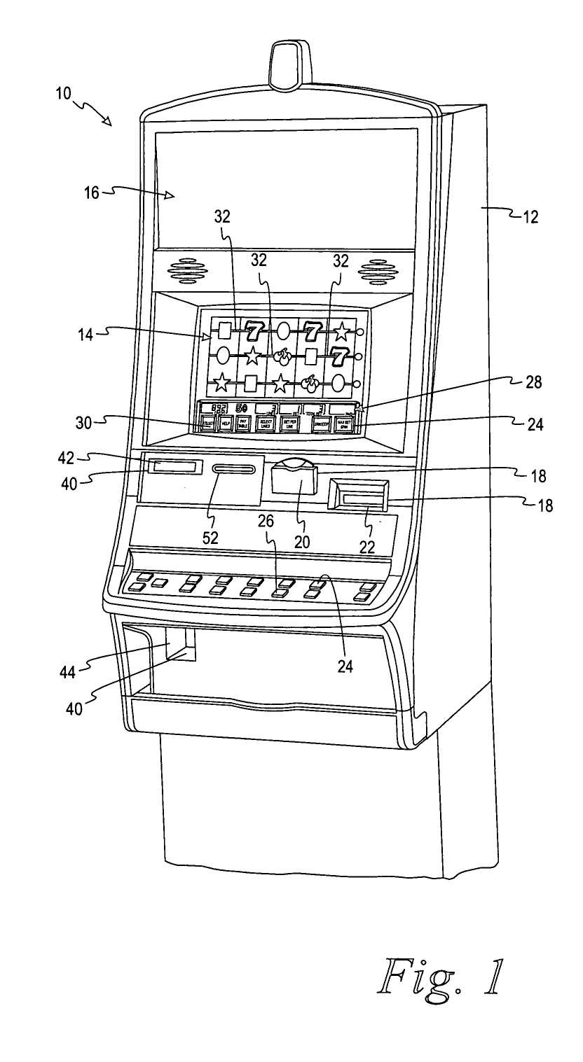

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits which are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an option on how to make their game selections. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12 or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual associated to at least one pay line 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

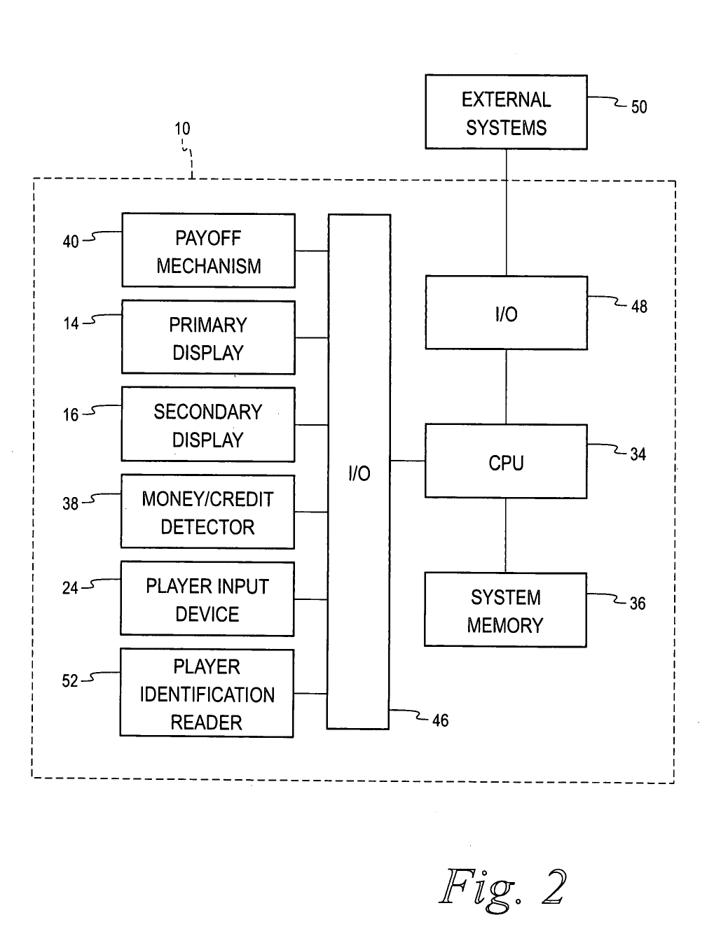

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10 bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

In some embodiments, the controller 34 is also used with the player information reader 52 to restore saved information. For example, in one embodiment, the player information reader 52 is adapted to receive and distribute tickets. The tickets each include a unique identifier. The unique identifier links the ticket to a file contained within either the system memory 36 or another memory located in the external systems 50. The file stores the player's biographical information as well as statistical information from past wagering games played by the player.

When a player inserts a ticket into the player information reader 52, the controller 34 obtains the unique identifier and causes the appropriate memory 36 to be searched, and the file containing the unique identifier matching the identifier on the ticket is retrieved. Any information contained in this file is then transmitted to the gaming machine 10.

In other embodiments, the player information reader 52 may include a card reader, and the unique identifier provided at the gaming machine 10 may be stored on a personal identification card, such as one described above. Or, the gaming machine 10 includes a radio frequency identification device (RFID) transceiver or receiver so that an RFID transponder held by the player can be used to provide the unique identifier of the player at the gaming machine 10 without the need to insert a card into the gaming machine 10. RFID components can be those available from Pacific Northwest National Laboratory (under the United States Department of Energy) of Richland, Wash.

In other embodiments, the player information reader 52 may include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, N.Y. Other biometric identification techniques can be used as well for providing a unique identifier of the player. For example, a microphone can be used in a biometric identification device on the gaming machine 10 so that the player can be recognized using a voice recognition system.

In summary, there are many techniques in which to provide a unique identifier for the player so that the statistical information accumulated by the player during a pervious wagering session can be stored in either the system or other memory 36.

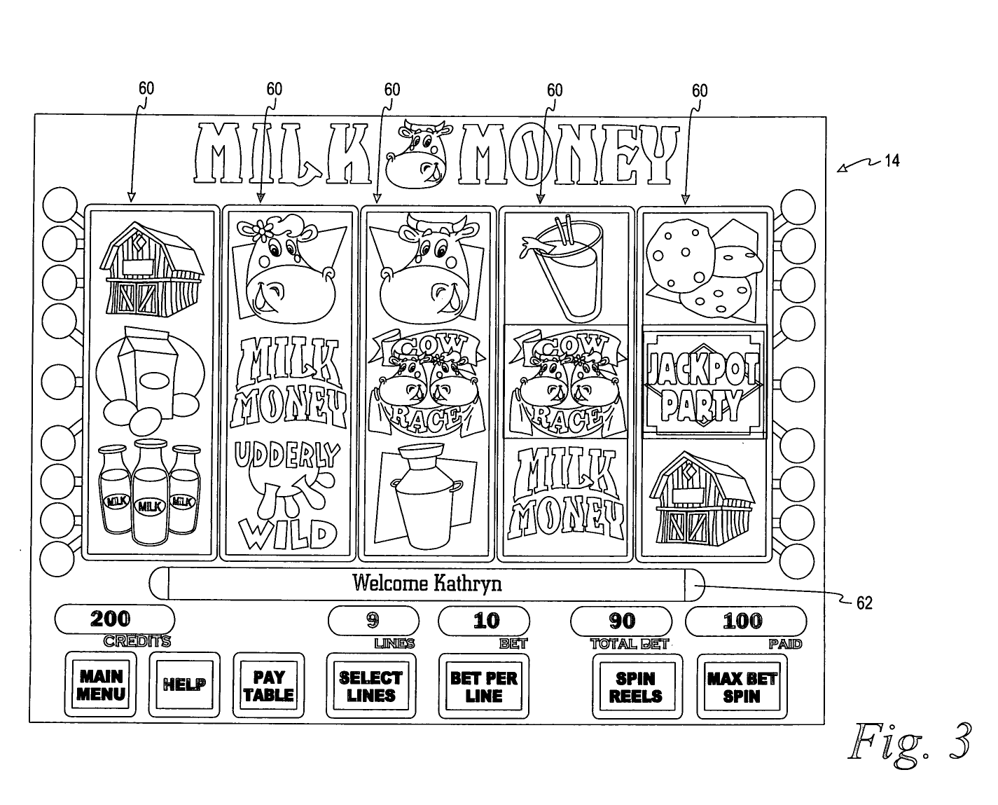

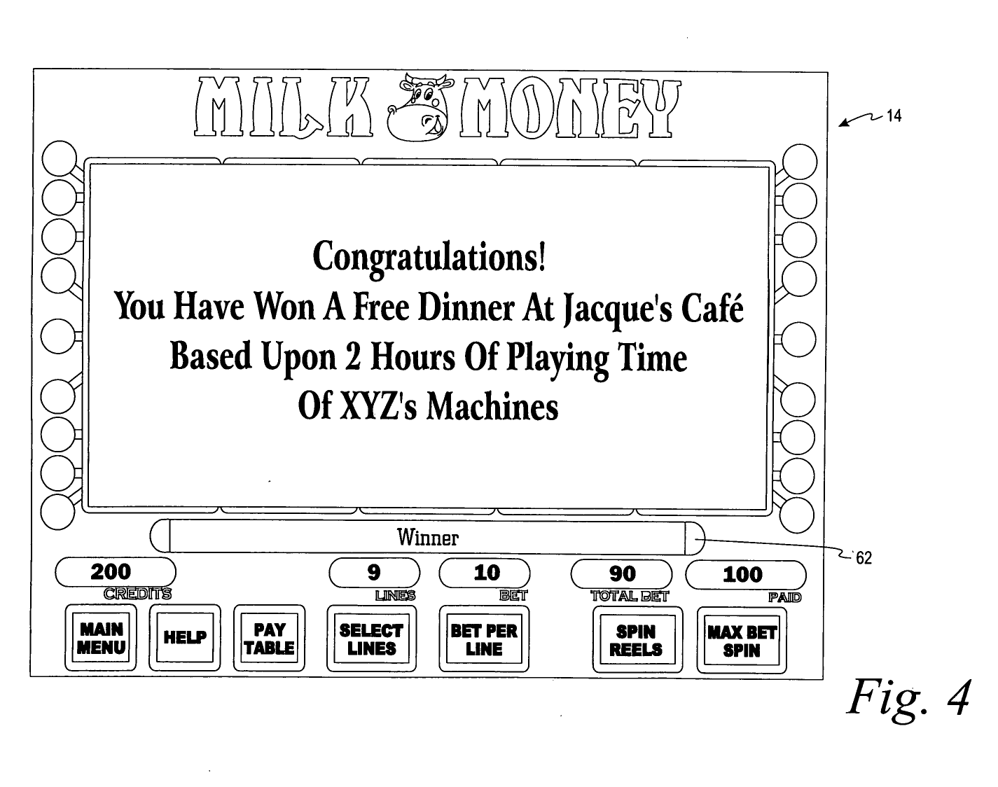

Turning now to FIGS. 3 and 4, two screens of the primary display 14 are shown to illustrate one embodiment of the present invention. FIG. 3 illustrates an initial screen of the primary display 14 after the player has inserted the wager amount and a player identifier. As shown, the main display includes a plurality of reels 60 for playing a basic game. The primary display 14 also includes a message box 62, which includes a message welcoming the player by name to the wagering game. The gaming machine 14 has retrieved the player's information from the memory 36 by using the unique identifier that is associated with the player.

As the player plays the wagering game, a predetermined criteria, or triggering event occurs, causing the primary display 14 to display the screen shown in FIG. 4. In this embodiment, the triggering event was a playing time of two hours on XYZ's machine, where XYZ is the manufacturer of the gaming machine 10. The reward is a free dinner at Jacques' Café, which may be a nearby restaurant or one located within the same casino as the gaming machine 10. A ticket, or coupon, for the meal would then be printed and output from the gaming machine 10.

The above embodiment illustrates one triggering event and one reward. In some embodiments, all of the triggers may be related to rewarding loyalty to a particular manufacturer's games. However, it should be understood that there are many triggers and many rewards, some of which will be discussed in more detail below. Any of the triggers may be combined with any of the rewards listed below, and the below list is merely a sample and not comprehensive. Also, regardless of the type of trigger or reward, the trigger requirement and reward may be displayed on the gaming machine 10. In other embodiments, the trigger and reward information may be posted on signage above the gaming machine 10.

Tiggers

Because customer loyalty can be demonstrated in a variety of forms, there can be numerous indicators that can trigger one or more of the loyalty based reward. Some of these are described below.

Time-On Machine

In one embodiment, the reward is triggered after the player spends a predetermined amount of time on the gaming machine 10 (as illustrated in FIGS. 3 and 4). The player's time-on the gaming machine 10 may be tabulated as time during one sitting, time on the gaming machine 10 over a predetermined period, such as a week, month or year, or as a percentage of total time on the gaming machine 10 over the gaming machine's 10 entire life.

For example, if the trigger is total time on the gaming machine 10 (over either a predetermined period of time or the gaming machine's entire life), every time the player inserts his or her player identifier into the gaming machine 10, the controller 34 (or a remote network controller) will access the player's account to retrieve the amount of time the player had previously used the gaming machine 10. Once the player begins to play the wagering game, the gaming machine 10 will begin recording and storing the amount of time the player is on the gaming machine 10. The current time will be added to the previous amount of time the player spent on the gaming machine 10 (whether over the life of the gaming machine 10 and/or over a specific amount of time).

If the time-on-device being measured is not cumulative over a set period of time, i.e., it is only counted during a particular sitting, then the gaming machine 10 will not access past playing times and will only count the current session. Once the player achieves the trigger time, the player will be granted the reward.

In another embodiment, the time tracked is the total time spent playing any gaming machines made by a particular manufacturer.

Time Playing Game-Theme

A variation on the time-on device trigger would be the length of time playing a particular game theme, such as the Men In Black series of games or MONOPOLY® games. The gaming machine would track how long (either in terms of continuous minutes or in terms of weeks, months, and years) a player has been loyal to a particular game theme. In this embodiment, every time a player inserted his or her player identifier into a gaming machine related to a particular theme, the gaming machine would access the player's account information and determine when the first time the player played a gaming machine with that particular theme. The gaming machine would also determine the length of time between the first time and the most recent time. Once the player has reached a predetermined period of time (e.g., a month, a year, three years), the player would be granted the reward.

In another embodiment, the theme may include any gaming machines made by a particular manufacturer.

In some variations of this embodiment, the player may be required to have played the game a certain number of times during this period. For example, the reward may not be given to someone who has only played any of the themed game twice during the past five years. However, a person who plays games with that theme regularly (monthly, even yearly) or has played it a predetermined number of times during the time period is eligible to achieve the trigger.

Time to Play New Games

Another method of triggering the reward would be calculating the time it takes a player to try out or play new wagering games on the market. As described above, every time the player inserts his or her player identifier into the gaming machine 10, the gaming machine 10 records various statistics regarding the player and the wagering game. In this embodiment, one of the statistics recorded is how long the particular wagering game has been on the market.

The gaming machine 10 will trigger a reward for a player who has met a threshold level of quickness in playing new games. For example, the gaming machine may review the player's account information to determine how quickly the player has played five of the ten newest wagering games. If the player has played them all within a predetermined allotted amount of time (e.g., within a month of each game's introduction), the reward may be triggered.

In another embodiment, the gaming machine 10 will trigger a reward for a player who has achieved a particular achievement in five of the ten newest wagering games. For example, a player who wins entry to the bonus game of five of the ten newest wagering games would win the reward. These rewards may also be granted in the context of a race or a scavenger hunt. In the race embodiment, it may only be the first player to achieve the bonus game in each of the ten newest wagering games that wins the reward. In the scavenger hunt embodiment, the first player to achieve (or find) all of the required events, such as a bonus game in one wagering game, a win of twenty five credits or more in another wagering game, and a free spin in another wagering game, is the player who wins the reward.

In some embodiments, the achievement may not be based on a random outcome, but instead may be based on the coin-in. In such an embodiment, the player would achieve the reward after wagering a predetermined, minimum number of coins in five of the ten newest wagering games, for example.

In another embodiment, the player's frequency of play in general may also be taken into account. For example, a player who plays wagering games once a week may have a lower predetermined amount of time than a player who only plays once a month. In other words, the player who plays once a week may trigger the reward once he or she has averaged playing the new game within a month of its introduction, while the player who plays once a month may trigger the reward once he or she has averaged playing the new game within three months of its introduction.

Coin-In-Device

In one embodiment, the trigger is the amount of coin (money) the player has wagered on the gaming machine 10. The trigger amount may need to be wagered during a single session, or it may be an amount over the life of the gaming machine 10 (or particular wagering game) or other predetermined period of time. Once the player has wagered a predetermined amount, the gaming machine triggers the reward.

In another embodiment, the trigger is the amount of coin (money) the player has wagered on any gaming machine made by a particular manufacturer.

Number of Times Played

Another trigger may be the number of times the player has played the particular wagering game within a predetermined period of time. For example, the gaming machine operator or manufacturer may only wish to reward players who play the wagering game at a certain pace or speed. For example, the gaming machine 10 may not reward a player who places one wager every two to three minutes, but may wish to reward a player who places one wager every ten seconds. Alternatively, the trigger could be based on the player's average play rate over a predetermined period of time, as opposed to difference between individual wagers.

Game-to-Game

Similarly, a manufacturer may wish to reward a player who moves from one of its gaming machines to another of its gaming machines. In this embodiment, the player identifier would record the time that the player ceased playing at the first gaming machine and the time that the player began playing at the second gaming machine. If both gaming machines are made by the same manufacturer and the time period between the game play is sufficiently short (e.g., five or ten minutes), the reward may be triggered.

In some embodiments the player identifier is a universal player identifier (can be used on all manufacturers'gaming machines). In that instance, the second gaming machine will record the time and also analyze whether the player used the card at another gaming machine after playing at the first gaming machine. For example, in this embodiment, the reward would not be based on the time between the game play, but instead on whether the player went directly to a gaming machine made by the same manufacturer as the first gaming machine. This would allow rewards to be triggered even if the player stopped playing for a long period of time, such as to eat a meal, sleep, etc. . . .

The manufacturer-to-manufacturer trigger may be accomplished by issuing a player a ticket. As the player leaves the first machine, a ticket encoded with the time would be issued to the player. The player would then insert the ticket into the second gaming machine, which would decode the time and trigger the reward. In some embodiments the ticket may include instructions to the player as to which game should be played next.

Manufacturer's Games Versus Other Games

Another triggering event may be a predetermined ratio of how often a player plays one manufacturer's wagering games (or gaming machines) in relation to other manufacturers'games using the universal player identifier described above. In other words, the manufacturer may wish to reward players who play its games more often than other manufacturers'games. For example, a player who plays a certain manufacturer's gaming machine twice as often as he or she plays other manufacturers'game may trigger the reward.

All Wagering Games Played

Another way to trigger the reward is to record when a player has played all of a manufacturer's wagering games. Once the player has played all (or a predetermined number) of the wagering games made by a certain manufacturer, the reward is triggered. In other embodiments, the reward is achieved when the player has played all of the wagering games made by a certain manufacturer in a predetermined locale, such as in a casino.

Number of Significant Wins

Another trigger may be the number of significant wins. This trigger rewards players who wager enough to win large jackpots. Every time the player wins a jackpot that is above a threshold level (e.g., 25 credits), the win is stored and linked to the player's identifier. Once the player had a predetermined amount of these wins, such as five or ten, the reward would be triggered. The significant wins could be linked to a particular wagering game, or to any wagering game. In other words, the reward may be for loyalty to a particular wagering game, type of game, or to a particular manufacturer.

Tell-A-Friend

In some embodiments, players may be rewarded for telling or enlisting friends (or other players) to play particular wagering games. A player may be awarded coupons, tickets, or other player identifiers that are to be given to friends. Once the friend's player identifiers are linked to the original player such that every time the friend plays, the information is also tracked in the original player's account. Once the friend has played a certain number of times (or any other of the previous mentioned triggers), the player would also be granted a reward. The player may also earn a reward for recruiting a predetermined number of friends to play the wagering games.

Rewards

Once a player has achieved a trigger, a reward will be granted to the player. These rewards can be any number of monetary or non-monetary rewards, some of which will be described below.

Coupon Rewards

One type of reward that can be issued is a coupon. When the player is finished playing the wagering game, leaving the gaming machine 10, or when the triggering event occurs, the coupon may be issued from the gaming machine 10 to the player. Various rewards can be granted by the coupon. In one embodiment, the coupon would be a voucher for free games for either that wagering game or for another wagering game. Providing free games for different wagering games allows an issuer, such as the manufacturer or casino, to introduce players to new wagering games (or re-introduce them to older wagering games).

In other embodiments, the coupons may provide free spins for the next wagering game in the series. For example, if a player triggers an award at a Men In Black wagering game, the reward may be free spins at a Men In Black 11 wagering game. This allows the manufacturer to generate interest in the newest games and to keep interest levels high in the current games. The coupon may grant the player free spins that can be played before the wagering game is available to the public (e.g., on a website or at a testing facility). This reward allows players to have the excitement of playing a game before it is available to the public.

Other coupons can provide the player with rewards at other venues. For example, the coupon may provide the player with a free meal at a local restaurant or a free show.

In some embodiments, the coupons may be used as a counter, with the coupon being stamped every time the triggering event occurs, allowing the player to achieve an even greater reward once a certain number of triggering events has occurred. For example, the player may receive a coupon the first time the player achieves a win of greater than 25 credits. Every other time the player achieves a win of greater than 25 credits, the coupon would be stamped. Once the coupon is stamped 10 times, the coupon is redeemable for a free dinner at an upscale restaurant.

In some embodiments, the initial triggering event (that causes the coupon to issue or be stamped) would also result in a smaller reward. In the example given above, each time the player wins an award of 25 credits or more, the player may be granted a free game or other type of reward. Then, when the player has achieved the second triggering event (of having other wins of 25 credits or more ten times), the player wins a second, larger reward. In other embodiments, the first triggering event does not trigger a reward, but instead only triggers the coupon and it is the completion of the coupon that triggers the reward.

Similarly, the coupons can allow for the collection of assets, such that when all the assets are achieved, the player is granted a final reward. For example, the player may need to achieve three different types of triggers (significant number of wins, a set amount of time on a gaming machine, and a predetermined wagering rate) to receive a large reward. Every time the player achieves one of the triggering events, the player would store that particular asset. Once all three assets are stored, the player would be granted a larger reward. For example, the player may have stored assets representing his or her three significant wins of 25 credits or more and four assets indicating that he or she has met the predetermined time on device four times. Once the player achieves the trigger for the wagering rate, the player would be granted the reward. The player would then still only need to achieve that trigger again to receive another reward. As with the stamped coupon embodiments described above, the player may only receive one reward once all the trigger conditions are met or he or she may win an award for each of the initial triggers.

Reserve A Machine

One additional way to reward players would be to allow players who have achieved a specific trigger to have the ability to reserve the gaming machine 10. The reward may allow the player to hold the gaming machine 10 while the player leaves for a drink or to go to the washroom. In this embodiment, the player would activate a “reserve” button, which could be a mechanical button or a button on the touch screen 28. The gaming machine 10 would access the player's account to ensure that the player has the ability (or has earned the reward) to activate this feature, and would then go into standby mode for a predetermined period of time (e.g., 10 minutes). Once the player returns, the player would re-activate the “reserve” button or activate another button on the gaming machine 10 to restart play. In the case where the player does not return in the allotted time, the gaming machine 10 would restart, allowing anyone to play.

While the gaming machine 10 is in standby mode, the gaming machine 10 could only be restarted by the player inserting his or her player identifier. The gaming machine 10 would read the card to determine whether the player is the same person who reserved the machine. If it is not, the primary display would display a screen informing the person that gaming machine 10 is currently in reserve.

In another embodiment, the player could reserve a gaming machine that is currently in use by another player. Certain players enjoy playing particular wagering games and even particular gaming machines. These players may become frustrated if someone else is playing the gaming machine that they want to play. However, the player may not want to sit and wait for the gaming machine to become available. In this instance, the player could access his or her account at another gaming machine or at a stand alone guest services terminal. The player would access a screen that allows him or her to reserve either a particular gaming machine or a particular wagering game. Once the gaming machine becomes free, the gaming machine would go into standby mode and the player would be alerted. The player would then have a set period of time to access the gaming machine before it would restart.

The player could be alerted by an announcement being made over a speaker system at the location where the gaming machine is being reserved. In other embodiments, if the player is playing a wagering game at another gaming machine, that gaming machine may flash a message to the player that the player's reserved gaming machine is ready. In other embodiments, the player may need to reserve the gaming machine through the gaming establishment's staff, who would give the player a buzzer that would beep or flash, similar to those used at many restaurants. In yet another embodiment, the player may have a cell phone number stored with the reservation, and a message would be sent to the player's phone indicating that the gaming machine is ready. The message may be an automated voice message, a live message, and/or a text message. The player may also leave a hotel room phone number or other land line on which to be notified. This would be especially useful for players who are waiting for a gaming machine at a hotel where they are staying.

VIP Machine

Similar to reserving a gaming machine, another reward is the granting a loyal player the chance to play on a Very Important Person (VIP) gaming machine. The VIP gaming machine is one that does not accept currency and the only people who can play are those who have achieved the trigger. Once the player achieves the trigger, the player will be notified that he or she has been awarded a predetermined number of free spins on the VIP gaming machine. The player may choose to continue playing at his or her current gaming machine and save the credits for another time, or the player may choose to leave the gaming machine to go play the VIP gaming machine.

Similar to the reward described above, the player may be notified of when the VIP gaming machine is available, so there is no waiting. Also, the player may choose to reserve the VIP gaming machine while he or she finishes his or her current wagering game.

The VIP gaming machine may be a roped-off machine with special lighting, indicating its special status. The VIP gaming machine may play a number of different wagering games, allowing the player to choose from his or her favorite games. Also, the VIP gaming machine, in some embodiments, operate as a bonus machine, offering only wins (i.e., the player is guaranteed to leave with credits). In other embodiments the VIP gaming machine may have better odds than a traditional wagering game. This means that some players will win larger and/or more often than at traditional gaming machines.

Insider Information

Some triggers may reward the player by giving them “insider information.” Insider information may include information on how long it has been since the particular gaming machine has hit, which some players feel give them an advantage. Other insider information could be hints in bonus games. For example, in bonus games where a player has to select an icon, a hint may point a player away from a game-ending icon, or “pooper.” In some poker wagering games, the insider information may reveal the next few cards to the player, to give him or her a better idea of whether he or she should hold or discard certain cards.

Group Incentives

In gaming machines that are hooked up to a bank of gaming machines, one reward comprises sharing the reward with all of the gaming machines at the bank. Once a player achieves a certain trigger, the player would receive a reward. Additionally, players at all of the gaming machines in the bank would also receive a reward. The rewards may be additional credits, free spins, multipliers, entry into a bonus game, progressive jackpots, etc. In some embodiments, when the reward is triggered, all of the players at the bank may gain entry to a bonus game. In other embodiments, only the triggering player may gain entry to the bonus game, but all of the other players at gaming machines at the bank may receive other rewards, such as free credits or free spins.

In another embodiment, the bank incentive can be expanded to any group of gaming machines that are linked. For example, it could extend to all gaming machines having wagering games of a particular theme, Alternatively, the incentive could be for all gaming machines made by a particular manufacturer in a casino. In another embodiment, the incentive could be for all gaming machines made by a gaming machine manufacturer.

Card Levels

In some embodiments, the player identifier may be a card. The card may have different levels, e.g., bronze, silver, gold, platinum. In some embodiments, when a player achieves a trigger event, in addition to receiving a reward, the player may earn points towards increasing the level of his or her card. Similar to credit cards that have different reward levels, the higher the level, the greater the perks and rewards for the player. In some embodiments, the rewards granted may increase with the level of the card. For example a player with a bronze card may win a reward of five credits upon achieving a triggering event. However, a player with a platinum card may win a reward of ten credits. In other embodiments, the higher levels may give the player additional perks, such as room upgrades or dinners at more upscale restaurants, etc.

In other embodiments, only players who have achieved a certain card level (e.g., gold) may generate the reward. For example, only gold card players may be able to generate the all-bank rewards discussed above.

Mathematical Rewards

In some embodiments, the rewards offered may be mathematical rewards. These include added wins, improved paytables, bonuses, free spins and/or multipliers. These types of rewards could be implemented on a player identifier's card, on a ticket, or may be awarded on the gaming machine as the player is playing the wagering game.

Regarding any of the rewards discussed in any of the above sections, there may be a time constraint as to when the player may redeem the reward. In terms of free spins, multipliers, or other rewards relating to the play of a wagering game, the reward may be restricted to when game play is traditionally slow. Similarly, for rewards relating to free events, e.g., hotels or meals, the reward may be restricted to off-peak times.

In other embodiments there is a gaming system with multiple gaming machines that are interconnected. Some of the interconnected gaming machines have a common feature, despite having different wagering games. The common feature could be the same linked bonus, link to the same progressive, similar theme, same manufacturer, etc. The rewards are linked to the common feature shared among the different gaming machines with that common feature.

Each of these embodiments and obvious variations thereof is contemplated as falling within the spirit and scope of the claimed invention, which is set forth in the following claims.

What is claimed is:

1. A gaming machine comprising:
a wager input device for receiving a wager to play a wagering game;
at least one display for displaying a randomly selected outcome; and
a player information reader for receiving a player identifier, the player identifier being associated with a player's account that includes statistics, wherein a reward is awarded in response to the statistics meeting at least one predetermined criterion associated with game play of a selected manufacturer's games.

2. The gaming machine of claim 1 wherein the player information reader is a card reader or a ticket reader and the player identifier is a card or a ticket.

3. The gaming machine of claim 3 wherein the mathematical reward is a free spin, multiplier, added wins, bonuses, or combination thereof.

4. The gaming machine of claim 1 wherein the reward is insider information.

5. The gaming machine of claim 4 wherein the insider information is statistical information regarding the gaming machine.

6. A method of conducting a wagering game on a gaming machine, the method comprising:
receiving a player identifier associated with a player's account;
monitoring information from the player's account, the information being related to wagering game play;
in response to the information meeting at least one predetermined criterion, awarding a reward, wherein the at least one predetermined criterion is associated with game play of a selected manufacturer's games.

7. The method of claim 6 wherein the information monitored includes time information, coin-in information, the number of times a player has played the wagering game, or a combination thereof.

8. The method of claim 7 wherein the information is time information, and the time information is total time on the gaming machine, the total time playing the wagering game, the total time playing all of the plurality of the selected manufacturer's gaming machines, time accumulated during a single sitting at the gaming machine, or any combination thereof.

9. The method of claim 7 wherein the information is coin-in information and the coin-in information is total coin-in the gaming machine, total coin-in all of the plurality of the selected manufacturer's gaming machines, coin-in during a single sitting at the gaming machine, coin-in playing the wagering game, or any combination thereof.

10. The method of claim 6 wherein the information monitored relates to the number of wagering games a player has played on all of the plurality of the selected manufacturer's gaming machines relative to the number of wagering games the player has played on a plurality of other manufacturer's gaming machines.

11. The method of claim 6 wherein the information monitored is the number of significant wins on the selected manufacturer's gaming machine.

12. A computer readable storage medium encoded with instructions for directing a gaming device to perform the method of claim 6.

13. The method of claim 6 wherein the awarding the reward is performed in response to a player recruiting another player to play the wagering game.

14. The method of claim 6 wherein the reward awarded is a coupon.

15. The method of claim 14 wherein the coupon is redeemable for free items, free spins, discounts for items, rebates for items, free games at any of the plurality of the selected manufacturer's gaming machines, free games at the gaming machine, free games for the wagering game, free games for a wagering game related to the wagering game or any combination thereof.

16. The method of claim 6 wherein the reward is the ability to reserve a gaming machine, the ability to play a reserved gaming machine that is only available to selected players, or any combination thereof.

17. The method of claim 16 wherein the gaming machine is part of a bank of a plurality of gaming machines, the method further comprising awarding a reward to each of the plurality of gaming machines in the bank when the reward is awarded.

18. The method of claim 6 further comprising issuing a manufacturer's card, the manufacturer's card having a plurality of reward levels, and, in response to achievement of a predetermined number of rewards, increasing the reward level of the card.

19. A gaming system comprising:
a plurality of linked gaming machines having a common feature, wherein each of the linked gaming machine includes
a wager input device for receiving a wager to play a wagering game, wherein the wagering game of one of the plurality of linked gaming machines is different from the wagering game of another of the plurality of linked gaming machines,
at least one display for displaying a randomly selected outcome; and
a player information reader for receiving a player identifier, the player identifier being associated with a player's account that includes information, wherein a reward is awarded, in response to the information meeting at least one predetermined criterion, the at least one predetermined criterion is associated with game play of a selected manufacturer's games.

20. The gaming system of claim 19, wherein the common feature is a bonus game, a progressive game, a theme of a wagering game, a manufacturer, or any combination thereof.
